(19) United States
(12) Patent Application Publication
(10) Pub. No.: US 2013/0151305 A1
(43) Pub. Date: Jun. 13, 2013

(54) Method and Apparatus for Business Drivers and Outcomes to Enable Scenario Planning and Simulation

(71) Applicants: Tolulope Akinola, Palo Alto, CA (US); Franz Aman, Palo Alto, CA (US); Martin Naraschewski, Walldorf (DE)

(72) Inventors: Tolulope Akinola, Palo Alto, CA (US); Franz Aman, Palo Alto, CA (US); Martin Naraschewski, Walldorf (DE)

(73) Assignee: SAP AG, Walldorf (DE)

(21) Appl. No.: 13/315,773

(22) Filed: Dec. 9, 2011

(51) Int. Cl. G06Q 10/06

(52) U.S. Cl. 705/7.25

(57) ABSTRACT

A driver tree model represents relationships among different levers of a business and desired outcomes. The driver tree may be connected to actual data from operational systems in the business in order to capture a realistic current status of the business. Changes to the drivers in the tree may enable managers and other decision-makers to assess, analyze, and otherwise understand the impact of those changes to various aspects of the business.

### BACKGROUND

The present invention relates generally to business planning and in particular to identifying factors in a business that increase likelihood of achieving a desired outcome.

Unless otherwise indicated herein, the approaches described in this section are not prior art to the claims in this application and are not admitted to be prior art by inclusion in this section.

Business drivers can be defined loosely as the main factors and resources which provide the essential marketing, sales, and operational functions of a business enterprise. The factors in a given business driver depend largely on the nature of the business under consideration. For example, if a business provides software development, their success factors will be specific to the information technologies industry. Success, for example, may rely on the ability to stand out among similar firms, for example, by providing timely and useful customer service and technical support, quick delivery of projects, and so on. Marketing, likewise, would employ tools such as direct sales, referrals from previous clients, pay per click advertising, search engine optimization, attendance to major programming conventions, and the like.

With customers demanding increased flexibility from a business, and with fewer resources available, companies need to react more quickly to market demands. Knowing what operational levers (i.e., factors and resources) within the organization can be altered to produce a positive effect on performance can be key to meeting these demands. Decision-makers must easily understand how varying options impact business operations in order to use resources as wisely as possible. A key question for any manager is to understand which of the multiple levers in their business can be moved to produce the most significant impact. In the absence of this knowledge, managers can waste time and resources on many seemingly “good” activities which, even when successfully executed, do little towards achieving business goals. Also, managers need to understand how their performance impacts the entire organization so they can choose wisely which goals to focus their resources on.

Another challenge that a business faces is resource management, especially since available resources are increasingly on the decline and/or expensive to acquire. Accordingly, resources within a business need to be distributed wisely. This is difficult to accomplish when executives and top-line managers are unable to determine the outcome of their ideas across the organization. Decision-makers need to quickly visualize how different scenarios would impact business operations before actually committing resources to implement them.

Without access to this kind of view, executives and their teams can waste enormous amounts of time on activities that end up doing very little to achieve the stated goals of the business. Real-time manipulation of operational levers within the business model can provide insight into which strategies would have a significant impact on overall performance, allowing resources to be utilized as effectively as possible.

Typical questions posed by decision-makers in a business may include inquiries like “How do I choose between these two business options?” or “How do I grow my business by 20%?” Executives generally turn to the following sources:

### Management Consultants

Organizations often hire management consultants for specialized expertise to help improve business performance. While their end-product may be valuable, hiring and briefing consultants can be time consuming and expensive. Consultants may spend several weeks understanding existing business problems and developing plans for improvement. It can be an expensive proposition, with minimum investment outlays sometimes totaling hundreds of thousands of dollars.

### Business Intelligence Software

Software solutions present data which allow users to analyze business performance. Business Intelligence (BI) tools are also valuable for accessing information to make sound business decisions, but it can be cumbersome and time consuming to use. The learning curve for this type of software can be fairly steep and often limited for use by business analysts. This usually means information may only be pulled on a quarterly basis, reducing the ability to move quickly with current data. These tools are usually unable to help users test theories.

### Spreadsheets

Spreadsheets are a mainstay in organizations today. Business modeling is often performed by a highly-trained business analyst whose turn-around time is slow and whose complex spreadsheets can be difficult to negotiate. These spreadsheets are also ill-suited to the collaborative nature of modeling exercises, which involve multiple parties making changes to targets and planning scenarios. They also tend to be used departmentally and thus the total impact to the enterprise and consequences for other parts of the business is unknown. Finally, trying to manage the sheer volume of spreadsheets within an organization, as well as the unintentional introduction of errors, can quickly become untenable.

The foregoing approaches, while valuable in their own right, each present a level of complexity, cost, and time expenditure that makes them impractical for regular use by executives. These and other issues are addressed by embodiments in accordance with principles of the present invention, individually and collectively.

### SUMMARY

In some embodiments, a method for visualizing a driver tree model for a business enterprise includes specifying a plurality of nodes and displaying the nodes on a display device. Each node corresponds to a business lever (driver) in the driver tree that can affect the performance of the business enterprise. Connections among the nodes are made to represent how the business levers (nodes) are interrelating and how changes in one node propagates through the driver tree. One or more calculations are received and associated with the nodes. Data to be associated with at least some of the nodes is received.

In some embodiments, the data may be manually entered by the user. In some embodiments, the data may be outputs of calculations associated with a node. In other embodiments, the data may be outputs from modeling information, such as from a spreadsheet.

The results of some calculations may be displayed as outcomes of the driver tree. In some embodiments, data feeding into a node may initiate update activity among the nodes in which computations are performed propagated through the driver tree. The displayed outcomes of the driver tree may be updated, thus displaying in near real-time how changes to data feeding into a node may affect the business.

In some embodiments, pre-existing hierarchies or taxonomies may be imported. A driver tree may be derived from parsing and otherwise analyzing the modeling information comprising the pre-existing model.

A graphical representation of the business drivers vis-à-vis a driver tree enables, with a quick glance, an understanding of the relationships and sources of value for their operations. Zooming into any of the nodes provides a deep dive into the key business drivers of this area of the business and allows the manager to simulate the effects of changes to the business drivers and create new “what-if” scenarios.

Given benchmark data (e.g., from internal or third party sources), it is possible to run automatic simulations to identify the most plausible changes to business inputs to help achieve the stated business goals. The software can act akin to a GPS device that guides the manager towards a solution given the destination goal. If the manager believes any of the recommendations are unattainable, she can reset them to more realistic levels and have the system re-optimize around this new constraint.

A driver tree graphical user interface (GUI) in accordance with principles of the present invention enables executives to simulate changes to business levers and review the impact of these changes against overall business performance. The GUI provides an intuitive user experience which minimizes the complexity associated with analysis and modeling tools. It presents all the backend data of the enterprise in a manner that can be grasped immediately.

### BRIEF DESCRIPTION OF THE DRAWINGS

FIG. 1 is a high level block diagram of a computer system in accordance with the present disclosure.

FIGS. 2, 2A, and 2B illustrates aspects of a GUI in accordance with principles of the present invention.

FIG. 3 is a flow chart highlighting a GUI process for building a driver tree in accordance with disclosed embodiments.

FIGS. 4A-4E are illustrative GUI screens shown the building process of a driver tree.

FIGS. 5A and 5B demonstrate the collapsing and expansion of portions of a driver tree.

FIG. 6 illustrates a process for importing a pre-existing hierarchy or taxonomy.

FIGS. 7A-7C demonstrate drilling down a driver tree.

### DETAILED DESCRIPTION

In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

A method in accordance with principles of the present invention includes displaying a visual representation of a business driver tree model, which can be thought of as a map that identifies and links key variables of business performance (i.e., business drivers). Once mapped, the impact of each driver on business outcomes can be established. For example, a driver tree model might identify the relationship between discount levels, list pricing, and final deal sizes or the relationship between regional operating revenue and overall corporate revenue. The combination of a business driver tree and the operational data that populates the model enables the prediction of business outputs based on changes to business inputs.

Visual access to a driver tree that represents the business enterprise enables executives to simulate processes and review the impact of changes against overall business performance and goals. For instance, a retail company CFO might want to evaluate the impact on profitability by opening a dozen new stores. Or, the COO of a manufacturing company might want to review the revenue impact of shifting production across a set of plants in different regions. As they navigate deeper into the graphical representation of the driver tree, users can refine their options on as frequent a basis as desired.

Accordingly, a driver tree graphical user interface (GUI) in accordance with the present invention is provided. Following are some guiding principles for a driver tree GUI.

### Interaction Model

The interaction focus for a driver tree GUI is creative, not analytical.

Compare email and instant messaging (1M) for example. Both these applications provide a means to communicate with others but your mindset while using each is different. Email communications are generally used for longer more professional messages while IM usage is a more familiar and instantaneous way to communicate with colleagues. When users sit in front of a spreadsheet or business planning software, the interface relays an expectation of ‘let's roll up our sleeves and get to work’. The user mindset is one of getting serious and buckling down to work. The driver tree GUI should not equate to “work” in this sense. The driver tree GUI should encourage creativity and experimentation. Users should never feel bogged down or concerned if an idea does not work out correctly the first time or if information is not all captured at once.

### The User Interface Defined

Analysts prefer a simple, lightweight configuration tool that can be used to define the taxonomy and hierarchies of the driver tree models. Driver tree models are very powerful and useful but have a low adoption rate in industry applications. While extremely helpful in understanding causes and impacts, driver tree models are typically viewed as difficult to implement—from defining the driver tree itself, to establishing the hierarchy and defining the data model. In accordance with the present invention, the business analyst chooses from a set of industry-specific driver trees included within the driver tree GUI to build out needed hierarchies, such as mapping product lines and their individual product relationships or mapping geographic locations and how they roll up to the worldwide business. The analyst builds up a driver tree model in a straightforward way and maps available data to the model.

Most executives have a good feel for the business and tend to work on hunches. They get excited about ideas and instinctively know if something is right or wrong, without usually knowing why. A driver tree GUI in accordance with the present invention can capture that type of thought process and have it flow straight into a driver tree model of the enterprise.

### Interface Connection Points

A driver tree GUI in accordance with the present invention may allow end users to issue requests for additional data as they manually input information to begin a creative session with the driver tree GUI. The ability to import third-party and benchmark data along with any driver tree models available for the driver tree GUI should be available to end users at all times.

### Connectivity

A driver tree GUI in accordance with the present invention can be available for use in an offline capacity as well, and should not be hampered by lack of connectivity. In embodiments, the driver tree GUI may provide a graceful degradation of function when used in a disconnected manner. An example of this degradation of functionality is email access while offline. Emails can still be drafted, reviewed and searched when not connected—only sending and receiving functionality is unavailable.

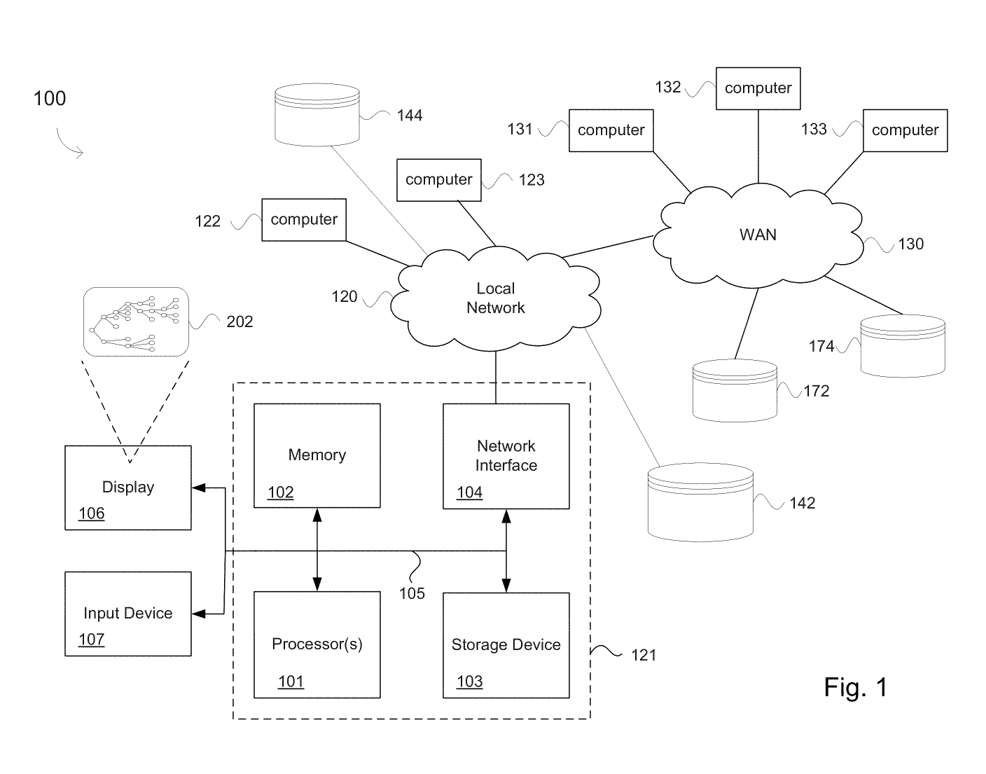

Referring to FIG. 1, a computing system 100 in accordance with embodiments of the present invention may include a plurality of computers 121-123 connected to a local communication network 120 within a business unit of the business enterprise (e.g., corporate headquarters, production facility, regional sales office, and so on). The local communication network 120 may connect to a company-wide wide area network 130, which may include connection to the Internet.

Computers 131-135 in the other business units of the business enterprise may connect to the either the local communication network 120 or to the WAN 130. Computers 121-123 and 131-133 may be configured as any suitable computing devices that may be used in the business. For example computers 121-123 and 131-133 may include tablet computers (e.g., Apple iPad® computer), laptop computers, desktop computers, and so on. The computers 121-123 and 131-133 may include various transactional systems used by the business; for example, PLM (product lifecycle management), CRM (customer relationship management), PPS (product production system), and so on. The computers may include storage servers; for example, storage server 142. More generally, the storage server 142 shown in the figure may be understood to represent the transactional and operation data of the business enterprise. Data sources that are external to the data stores of the enterprise are shown by reference numerals 172 and 174, and will be discussed below.

A typical computer 121 may include a data processor subsystem 101 comprising one or more data processing units. The computer 121 may include a memory subsystem 102 which may comprise any combination of random access memory (usually volatile memory such as DRAM) and non-volatile memory such as FLASH memory, ROM, and so on. The computer 121 may include a storage subsystem 103 comprising one or more storage devices such as hard disk drives and the like. The storage subsystem 103 may include remote storage systems; e.g., for data mirroring, remote backup and such. A network interface subsystem 104 can provide access to the network 120. A system of buses 105 may interconnect the foregoing subsystems, providing control lines, data lines, and/or voltage supply lines to/from the various subsystems.

The computer 121 may include a suitable display(s) 106 and input devices 107 such as a keyboard, a mouse input device, a voice input device, and so on. In some embodiments, typical devices may include tablet computers such as the Apple iPad® tablet computer which employs a touch sensitive screen that serves both as a display and as an input device. Other devices include laptop computers that use a built-in input device such as a touch pad or an external input device such as a mouse, and desktop computers.

Computer executable program code may be stored on the memory subsystem and/or storage subsystem 103. When the computer executable program code is executed by the data processor subsystem 101, the computer 121 may operate with the display 106 to provide a driver tree graphical user interface (GUI) 202 allowing a user to build and display a driver tree model of the business enterprise in accordance with principles of the present invention. The driver tree model may be stored in the computing system 100. For example, the driver tree may be stored on the storage subsystem 103 of the computer 121, or on a storage server 142, and so on. The “user” may be a human user, or an automated process running on another computer.

A driver tree is a type of model that represents aspect of a business enterprise. A driver tree associates business levers to outcomes. “Business levers” are aspects of a business enterprise that a decision maker (e.g., executive, manager, etc.) can change in order to improve some aspect of the business. “Outcomes” are the effects on various business elements as a result of adjusting the business levers. For example, the production levels of a widget may be a business lever that a manager can adjust, namely increase the production of widgets or decrease the production of widgets. An outcome of adjusting the production levels of widgets may be the total revenue collected in a sales area where widgets, and other products of the business, are sold.

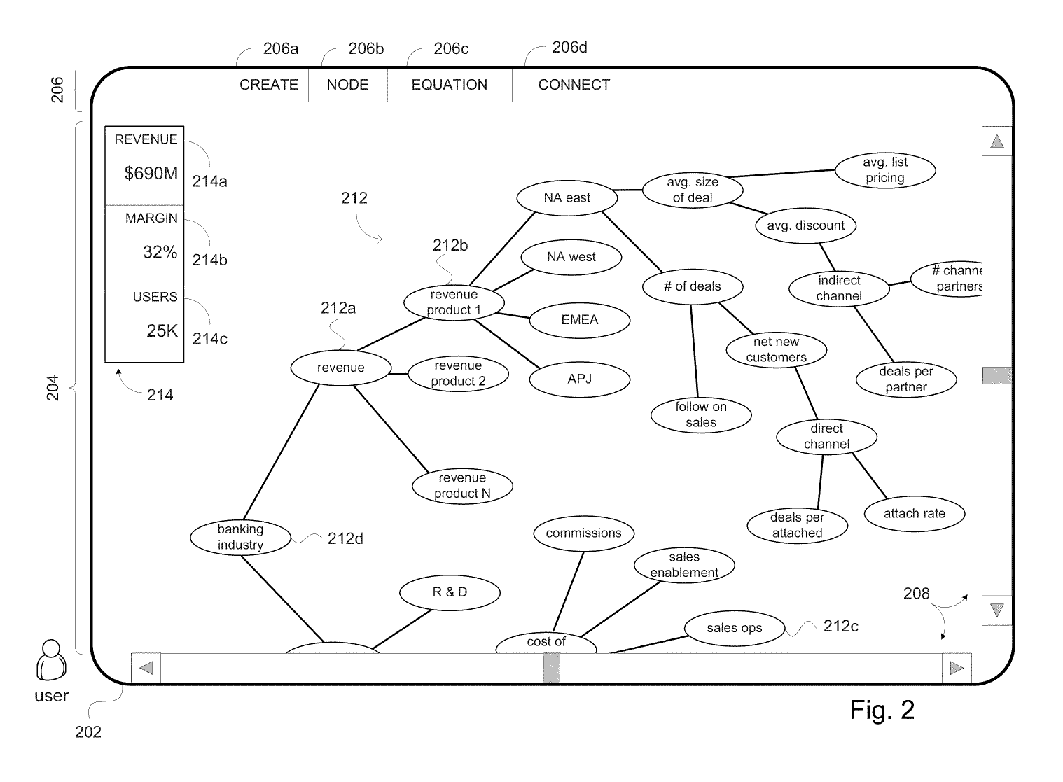

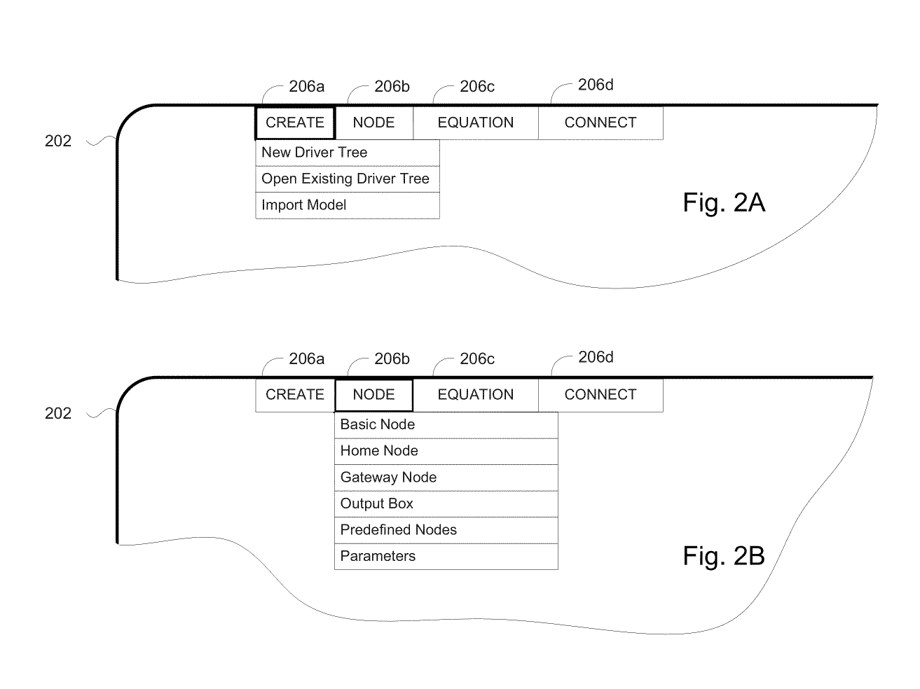

In some embodiments, a graphical user interface such as the driver tree GUI 202 illustrated in FIG. 2 may be employed to create, display, and otherwise manipulate a graphical representation of a driver tree 212 for modeling a business enterprise. The driver tree GUI 202 may include a display area 204 for displaying the driver tree 212, along with a set of menus 206 to allow the user to build the driver tree 212. Scroll bars 208 allow the user to scroll the display area 204. The driver tree 212 includes an outcomes view 214 to display business performance metrics computed from the driver tree.

The driver tree 212 may comprise nodes that represent various business levers of the business and links between the nodes to represent relationships among the business levers. For example, node 212a may represent the total revenue generated by the business. Node 212b may represent the total revenue generated from sales of “product 1.” A node 212c may relate to the overhead for sales operations, and so on.

The outcomes view 214 represents various measures of business performance (e.g., total revenue, size of customer base, and so on) that are of interest to decision makers, and are determined from the driver tree 212. In the example shown in FIG. 2, the outcomes view 214 comprises three separate outcome windows 214a, 214b, and 214c. For example, a REVENUE measure 214a is an outcome window that may be computed directly from node 212a by summing the revenue collected from the sales of products 1 to N. A MARGINS measure 214b may be computed from the driver tree 212, and so on. Changes made to a node in the driver tree 212 (i.e., adjustments to one or more of the levers in the business) may propagate through various nodes in the driver tree, and may manifest as changes to the computed measures of business performance metrics displayed in the outcomes view 214.

Various menus 206 may be provided in the display area 204. In some embodiments, the menus 206 may be drop-down menus that provide the user with a list selections to facilitate creating a new driver tree or modifying an existing driver tree. Referring to FIG. 2A, for example, a portion of the driver tree GUI 202 shows a Create menu 206a with an example of menu items. The user may create a new driver tree. A suitable dialogue box may be presented to allow the user to name the driver tree, designate its storage location, and so on. The user may open an existing driver tree. A suitable dialogue box may be presented that allows the user to designate the location of the existing driver tree. The user may import a business model that may then be converted into a driver tree. This aspect of the present invention will be discussed in more detail below.

FIG. 2B shows options for selecting different nodes via a Node menu 206b. The nodes represent the business levers of the driver tree 212 which can be manipulated to assess how the business enterprise will respond. In some embodiments, various node types may be provided, including a basic node, a home node, a gateway node, an outcome window, and predefined nodes. A “home” node designates the root of the driver tree, from which all other “basic” nodes branch out. In FIG. 2, the “banking industry” node 212d is an example of a home node.

In some embodiments, a node may be designated a “gateway” node. A node in the driver tree that is a gateway node is not an actual node, but rather is a link an actual node; the actual node being located elsewhere in the driver tree. A gateway node may be used to represent a non-hierarchical relationship among nodes.

An “outcome window” is a type of node that shows a result. More particularly, the results displayed in an outcome window reflect the effects of changing one or more of the nodes (business levers) of the driver tree. Examples of an outcome window are the individual outcome windows 214a-214c shown in FIG. 2.

A “predefined node” may be defined by a designer to build library of nodes specific to the particulars of a business enterprise. Predefined nodes allow for a degree or re-usability. A user may define some nodes for a particular driver tree model and realize that the nodes can be used in other models. The user may store them in a common location (e.g., node library, 144 in FIG. 1) for other users to access. A subsequent user may then access the node library 144, make a copy of it and use it, or modify it.

The Node menu 206b may include a Parameter menu item. As will be discussed below, this menu item may be used to allow the user to define parameters for a node.

Returning to FIG. 2, an Equation menu 206c may be provided to allow the user to define quantitative relationships (e.g., equations, formulae, computations, etc.) among the nodes. For example, an equation for the “revenue” node 212a may be a summation of the revenue for each product 1 thru N. The Equation menu 206c may be used to define a function for a node. For example, suppose a node is configured to receive data for individual sales. A function may be defined to combine the individual sales into a more meaningful value; e.g., a daily average sales figure, a monthly average sales figure, and so on. A node may be associated with more than one function, so that different metrics may be output by the node. A suitable interface (e.g., equation editor) may be presented to the user to define or otherwise specify functions and equations to define and relate different nodes in the driver tree 212.

A Connect menu 206d may be provided to allow the user to define connections between the nodes. Connections between the nodes (business levers, drivers) represent the effect each driver has in the model. When a driver is changed (i.e., by changing the data that feeds into the node), computations are performed to update each node, and the updates propagate to the other nodes depending on the connections defined. The outcome windows (e.g., 214 FIG. 2) reflect the effect the changes had when the updates have propagated throughout the driver tree.

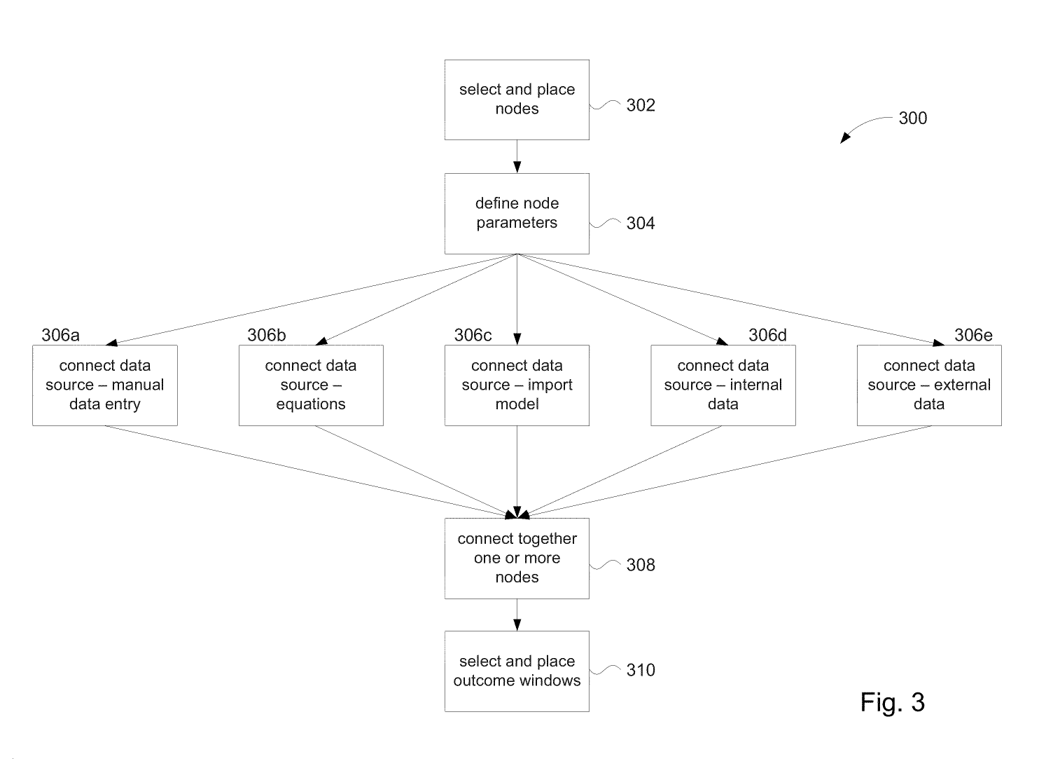

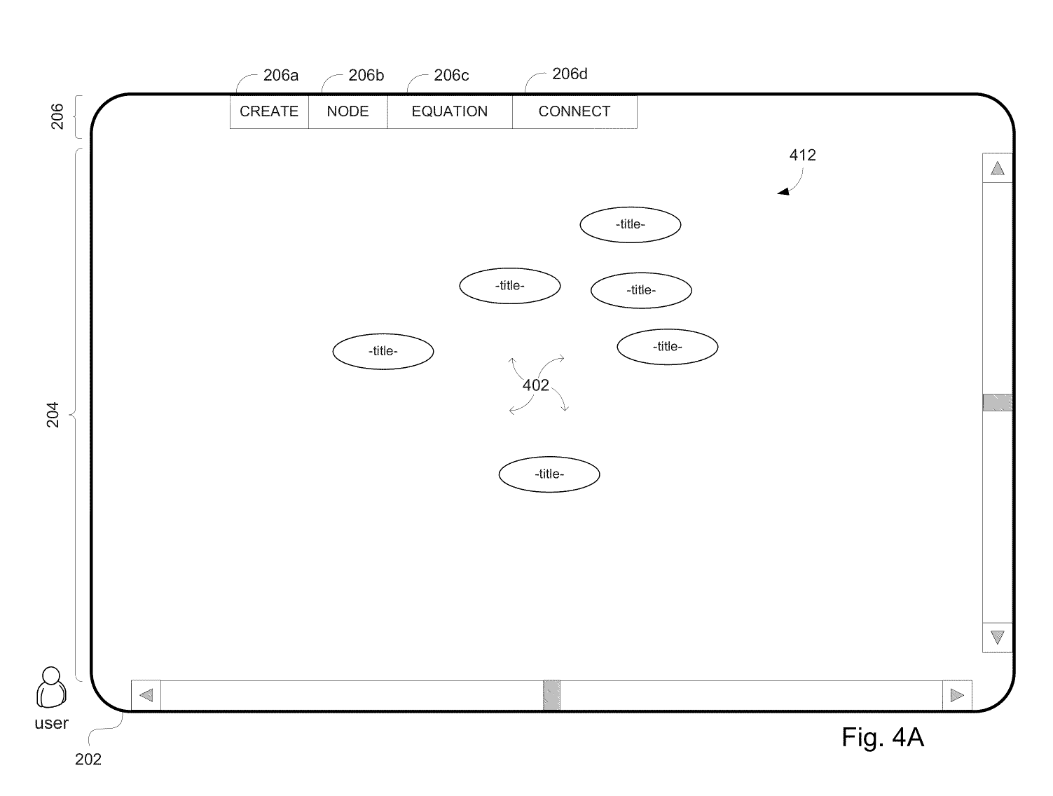

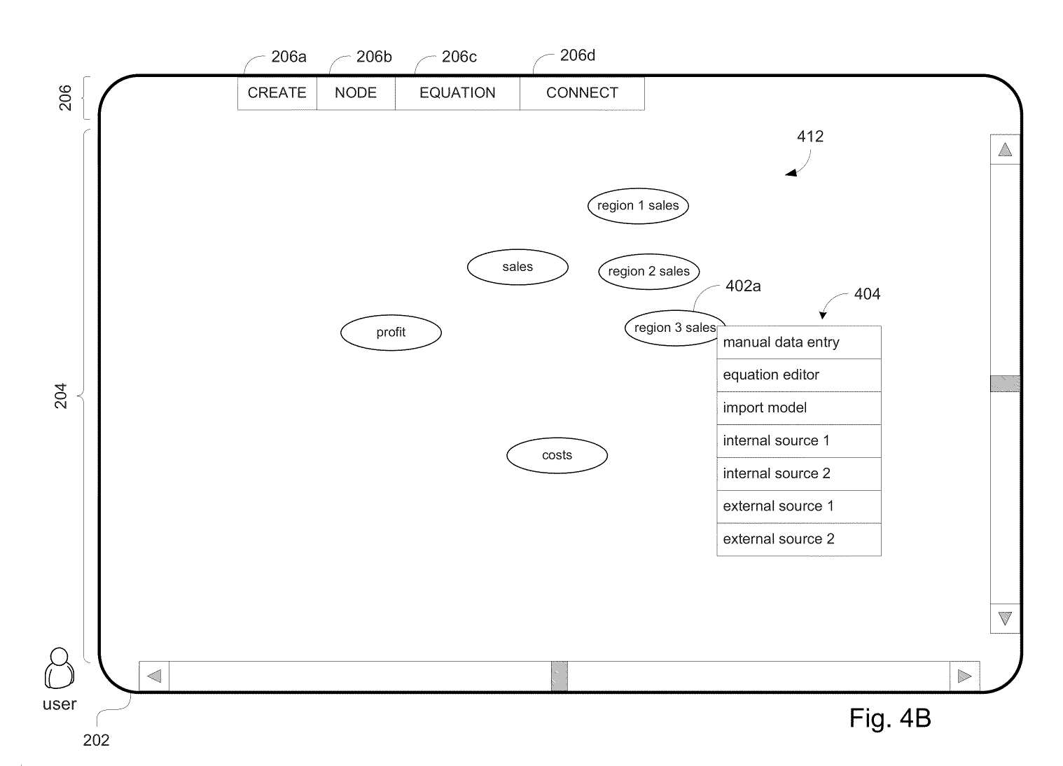

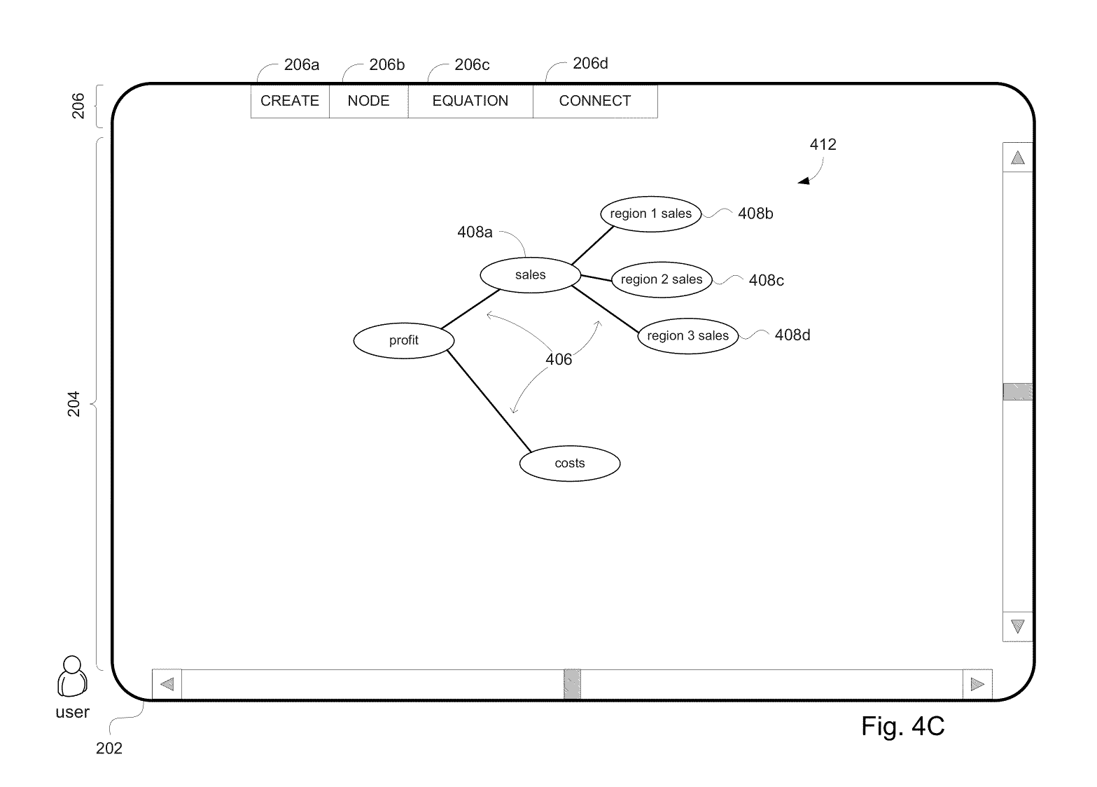

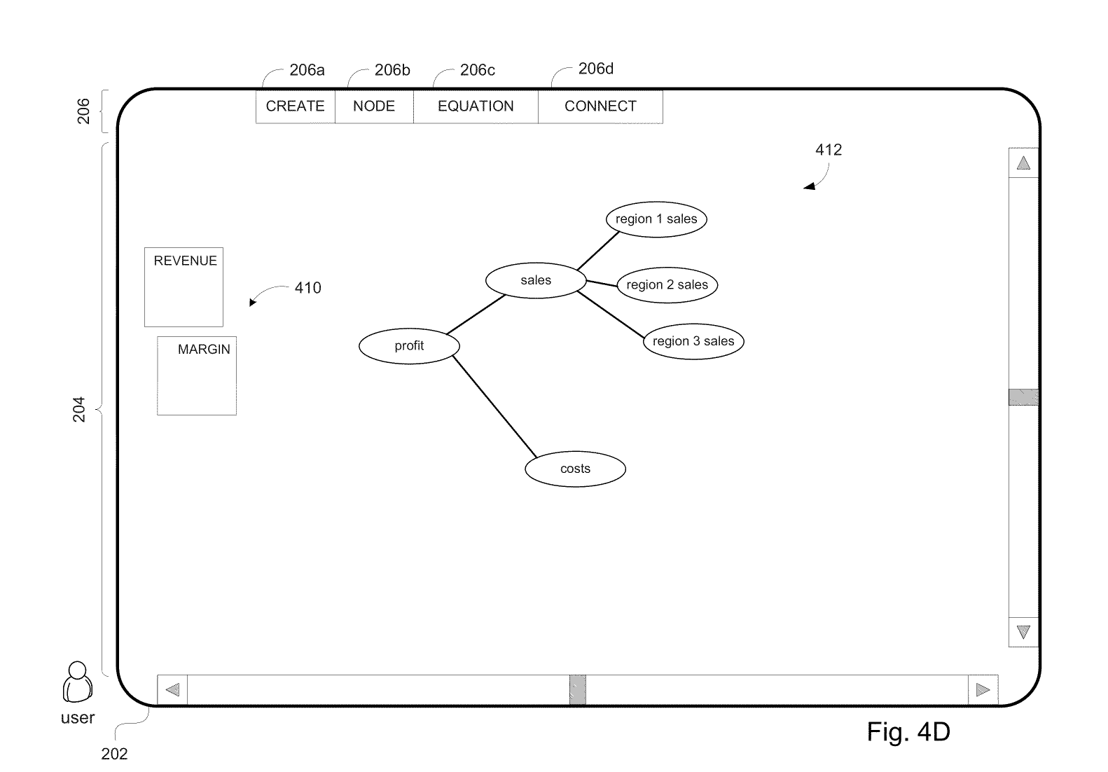

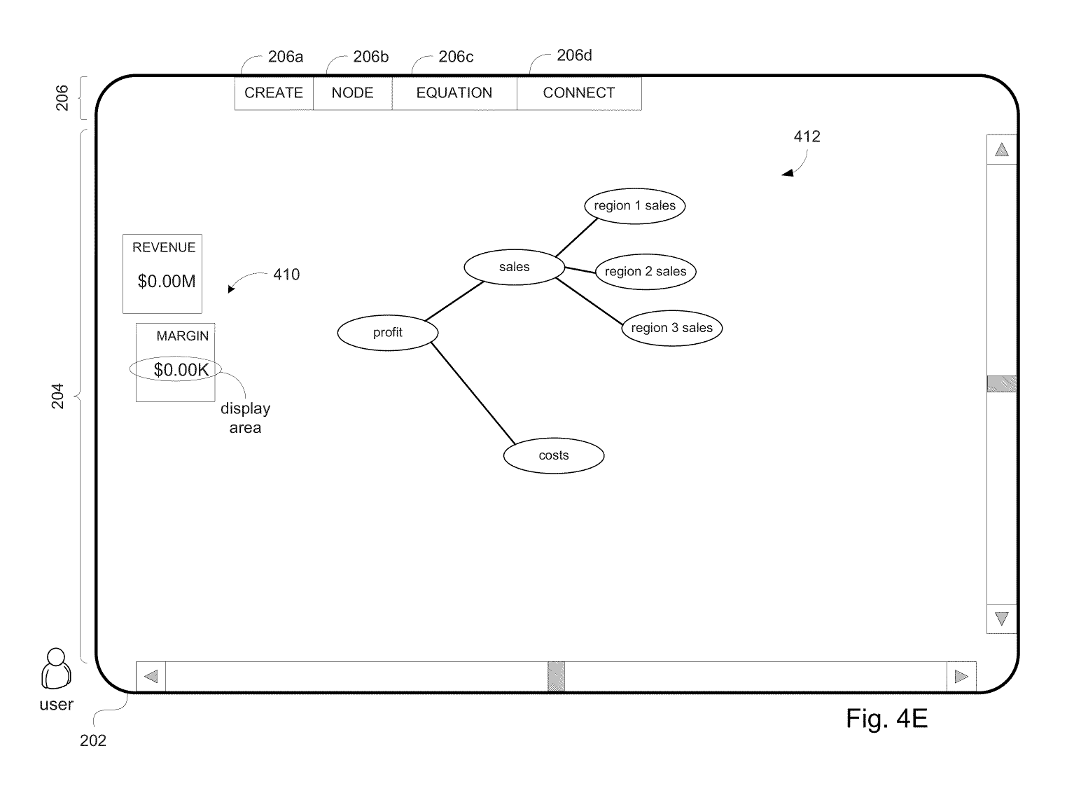

Referring to a flowchart 300 in FIG. 3 and driver tree GUI examples in FIGS. 4A-4E, an example of the construction of a new driver tree 412 in accordance with an embodiment is described. It will be appreciated that the steps set forth in the flowchart 300 are not necessarily performed in the shown. For example, the step of connecting nodes to each other (step 308) may be performed prior to connecting data sources to the nodes (steps 306a-306e).

In a step 302, one or more nodes may be selected and positioned. For example, the user may access the Nodes menu 206b and select a node. An appropriate image of the selected node (e.g., the image may vary depending on the node type) may then be displayed in the display area 204. The user may select a node by “clicking” (e.g., using a mouse input device) on an already displayed node and perform a “cut and paste” operation to create a duplicate node. The user may position the nodes in the display area 204 to reflect the hierarchical relationship of the driver tree 412 being constructed. FIG. 4A shows, for example, a plurality of nodes 402 that have been selected and placed. The nodes have not yet been given names, and so they are displayed with a default name; e.g., “—title—”.

In a step 304, parameters for each node may be specified; e.g., via the Node menu 206b. Parameters may include, for instance, the number of inputs to the node, the number outputs from the node, the data formats of the inputs and outputs, a name of the node, and so on. The size of the node may be specified. For example, outcome windows may have different sizes. The size of an outcome window may be made variable as a function of some calculated value. For example, suppose an outcome window is defined for total sales in a sale region, and the one such outcome window is define for each of the sales regions in the mid west. Tying the size of the outcome window (e.g., its height) to the sales figure will cause each outcome window to vary in height depending on the sales figure, thus providing a visual comparison of regional sales figures. Other parameters may include specifying a color scheme for displaying a node. For example, shades of red and shades of green may be used to color a node that represents sales depending on whether sales are up or down from previous sales, and the color shading may be a function of the magnitude of the change.

The user may connect each node to a data source for feeding data into the node. In some embodiments, a node may be connected to one or more data sources. In an embodiment, a drop-down menu may be used to select from among multiple data sources for a given node. FIG. 4B, for example, illustrates a drop-down menu 404 associated with a node 402a. The drop-down menu may be accessed by “mousing over” the node 402a and “right clicking” on the mouse. A display of the drop-down menu 404 may present a list of data sources to select from.

In a step 306a, the data source may be manually entered data. The node 402a would be “connected” directly to the user who is manually entering data for the node. This kind of data source would be especially suitable for an executive who wants to perform “what-if” analyses. A suitable interface (e.g., a spreadsheet style input screen) may be presented to facilitate data entry of data to be associated with the node 402a.

In a step 306b, the output of an equation may be connected to the node 402a. The Equation menu 206c may be invoked to access an equation editor, or the drop-down menu 404 may include the equation editor among its selections. A suitable equation may then be defined, and its output or outputs may then serve as data that feed into the node 402a.

In a step 306c, the user may import a model as the data source. For example, an Excel® spreadsheet may generate data that feeds into the node 402a. One or more cells in the spreadsheet may include a function that generates data. One or more such cells can be associated with the node 402a as a data sources. Importing a model may allow for more complex computations to be developed and incorporated into the driver tree 412. It is appreciated that models generated by modeling tools other than an Excel® tool may be imported.

In a step 306d, the user may connect the node 402a to the enterprise's transactional or operational data, or to other data generated by the enterprise. Connecting a node to an internal data source may require assistance from the enterprise's information technology (IT) department, where IT personnel may need to configure data connections in order to transform certain slices of data or data field labels. Access to the data may require conforming to the enterprise's security procedures and policies.

In some embodiments, the user may want to access external sources of data in addition manual data entry or referencing the enterprise's internal transactional and operational data. Depending on the aspects of the business enterprise being modeled by the driver tree, better outcomes may be obtained when some nodes are is populated by data obtained from sources outside of the business enterprise. In accordance with principles of the present invention, data access is not confined to the enterprise's internal transactional and operational data; data access may also include third-party sources and additional industry content.

For example, access to industry best practices data may be important for a number of reasons. It may be helpful to benchmark the business against not only historical results, but also the industry as a whole. For example, standard best practice figures for key industries and third party data may be available from commercial data sources such as IDC, Gartner Inc., Dataquest Ltd., and the like. Data streams from these source may provide market size growth data for most industries that may be useful for the driver tree. As an example, being able to understand the enterprise's position within a certain market category can be valuable. The user can look at the enterprise's growth relative to the category growth rate and provide immediate context to the enterprise's business numbers.

Accordingly, in a step 306e, the user may connect the node 402a to an external data source. Third party data sources (e.g., data stores 172, 174 shown in FIG. 1) can extract the data, transform it, and input it into the nodes of the driver tree in a way that conforms to the established business rules. As an alternative, third party content may be made available as purchased information, or via subscriptions to data content streams, and so on.

In a step 308, connections between the nodes may be defined by drawing a line between two nodes. For example, the user may click on the Connect menu 206d to enter a mode where the user can draw connecting lines between nodes. FIG. 4C, for example, shows that links 406 have been defined among the various nodes in the display area 204. In some embodiments, a consequence of defining links between nodes, establishes additional data sources for some nodes. For example, node 408a may import data from nodes 408a-408d by virtue of the links. Accordingly, the user may invoke an equation editor (e.g., via Equation menu 206c) to define a function (e.g., summing) for node 408a that is based on data from nodes 408a-408d. For example, an Excel® style notation may be used to express a sum function for node 408a:

=sum(region 1 sales,region 2 sales,region 3 sales).

In a step 310, the user may select and place one or more outcome windows 410 in the display area 204. For example, the user may use the Node menu 206b and select the “Outcome Window” entry to display an outcome window graphic in the display area 204. The user may select an outcome window already displayed in the display area 204, and perform a cut and paste operation to make a duplicate of the outcome window which may then be modified. FIG. 4D shows an example of two outcome windows 410 in the display area.

In a step 312, the user may connect one or more data sources to each outcome window 410. The data source for an outcome window 410 may be based on outputs of one or more nodes in the driver tree 412, or may be based on computations performed on one or more nodes in the driver tree. The outcome window 410 includes a display area for displaying a result that is obtained from the data sources or computations.

The discussion will now turn to the idea of just-enough-data processing. Users are often faced with difficulties when amassing vast amounts of data needed to address specific business problems. The inventors realized that not every piece of relevant data is needed in order for an executive to make a decision. Executives tend to have several options available or a go-no go decision to make. These scenarios do not dictate a need for the most up to date or accurate information. Ballpark information in this case is more than adequate.

Accordingly, embodiments in accordance with principles of the present invention can accommodate any degree of available data that a user might have on hand in order to begin using the driver tree 412. Even with back-of-the-envelope calculations that are manually input (e.g., step 306a), users may get immediate and meaningful results. Once more information or a database connection (e.g., steps 306d, 306e) is available, the driver tree model 412 can be refined and refreshed to provide greater accuracy.

Accordingly, in some embodiments, as incoming data feeds into the nodes of the driver tree 412, the data is computed and updates are propagated to the connected nodes, where subsequent computations may be performed. The process is repeated until all updates have propagated through the driver tree. If an outcome window 410 is connected to one or more of the nodes, then its display area will update as the nodes in the driver tree 412 are updated. In this way, the user can obtain near instant responses from the driver tree to their inputs, which for example can greatly facilitate performing “what-if” analyses.

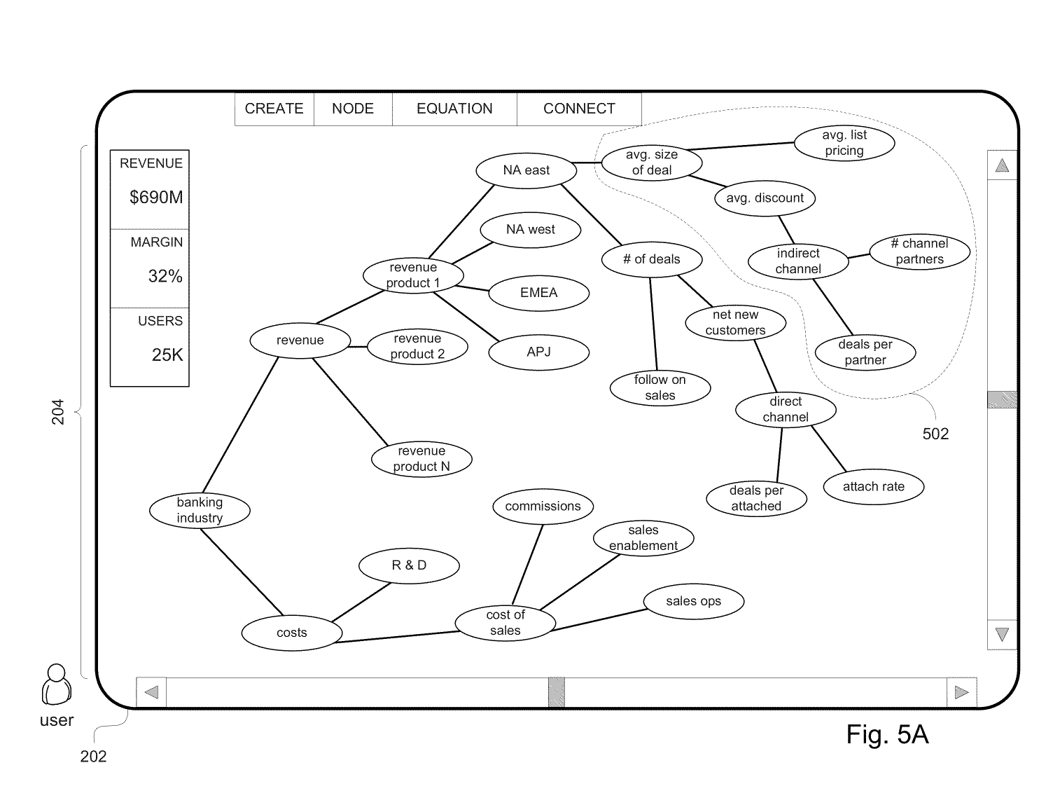

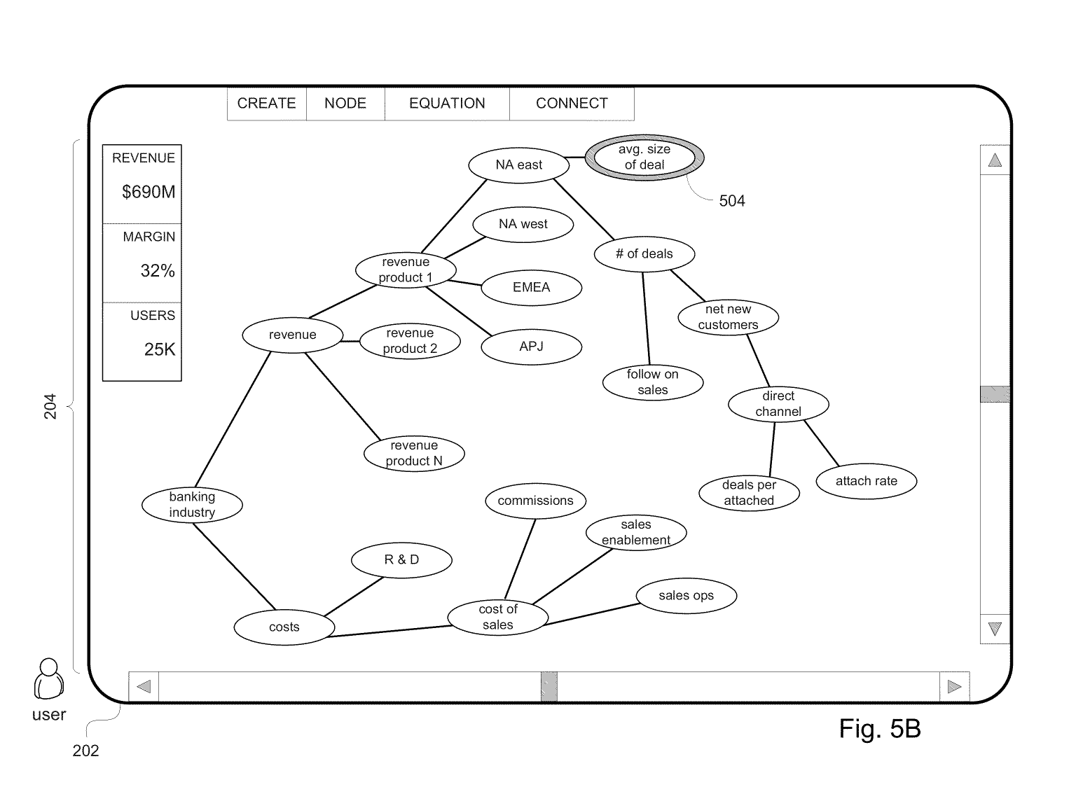

Referring now to FIGS. 5A and 5B, in some embodiments, the user may select a group of nodes and collapse that group. This capability may be useful to reduce the size of an unwieldy driver tree. The selection of a group of nodes may be made by drawing a selection box 502 (FIG. 5A) around the nodes of interest. Other selection techniques may be used; for example, individually selecting the nodes of interest. The user may “double click” on a node to automatically select a sub tree rooted at the double-clicked node, and so on. The user may then invoke a command to replace the selected nodes with a replacement node 504 (FIG. 5B) that is represented by a suitable graphic. The reverse process of expanding a collapsed sub tree may be invoked, for example, by double clicking on the replacement node 504.

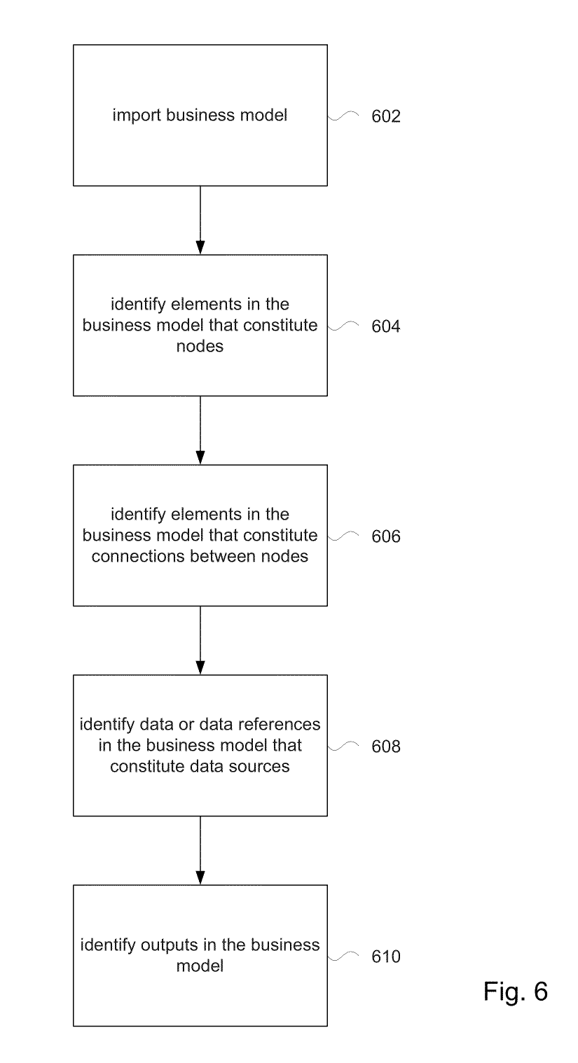

Referring now to FIG. 6, in some embodiments, the driver tree GUI 202 may import pre-existing business model hierarchies or taxonomies for conversion into a driver tree. An example, is an Excel® spreadsheet that may have been developed to model a part of the business enterprise. In some embodiments, modeling information that comprises a pre-existing model may be parsed and translated into elements to derive a driver tree that can be supported by the driver tree GUI 202. Once a driver tree derived from a hierarchy or taxonomy is available within the driver tree GUI 202 environment, the derived driver tree can be revised or simplified if required.

Accordingly, in a step 602, a pre-existing business model may be specified, for example, via the Create menu 206a in FIG. 2. A suitable dialogue box may be presented, allowing the user to designate the location of the pre-existing business model.

In a step 604, the modeling information comprising the pre-existing model is parsed to identify elements in the model that correspond to driver tree nodes. For example, in a spreadsheet, the cells which contain calculations may correspond to driver tree nodes. Accordingly, cells which contain calculations (“formula cells”) may be mapped to nodes in the driver tree. Labels associated with formula cells may be used to name the nodes. The calculations associated with formula cells can be associated with the nodes. Other node parameters (e.g., size, color, etc.) may be set to default values. The user can subsequently access the resulting driver tree to further refine the driver tree.

In a step 606, connections among elements in the pre-existing model are identified. This step may involve inspecting metadata that may be contained in the modeling information which indicate connections between elements, performing semantic analysis on the modeling information to infer connections, and so on. For example, in a spreadsheet, inferences may be drawn about relationships among formula cells based on their associated calculations. For example, if the output of one calculation is used as a term in another calculation, then their associated cells may be deemed to be linked.

In a step 608, data or data references appearing in the pre-existing model may be used to identify data sources for the driver tree. For example, actual hard-coded data in the pre-existing model may constitute manually input data for a node. The pre-existing model may include references for importing data, which may include data sources internal to the business enterprise or outside of the business enterprise. Such references may be connected to the driver tree nodes.

A business model typically produces one or more outputs; e.g., total sales, projected profits, etc. Accordingly, in a step 610, any such outputs in the pre-existing model may be candidates for being mapped to one or more outcome windows (e.g., 214, FIG. 2). Parameters for defining the outcome window (e.g., data formats, sizing of the window, and such) may be set to default values, allowing the user to later on come in and further refine, correct, customize, or otherwise modify the resulting derived driver tree.

Embodiments of the driver tree GUI 202 in accordance with principles of the present invention allow users to model and build a driver tree that can provide a user with an understanding of the business enterprise that is expressed through a visual representation of may data views. For example, suppose the user would like to understand whether poor performing sales are due to a product's feature set or its go-to-market strategy. Using the driver tree GUI 202, the user might look at the product's sales performance across different geographies and if sales are decent in certain regions but not others then outcome windows 214 provided in the driver tree GUI 202 might indicate that the product itself is sound. If product performance is equally bad across all regions, the driver tree GUI 202 might indicate that the product is not meeting the needs of the market.

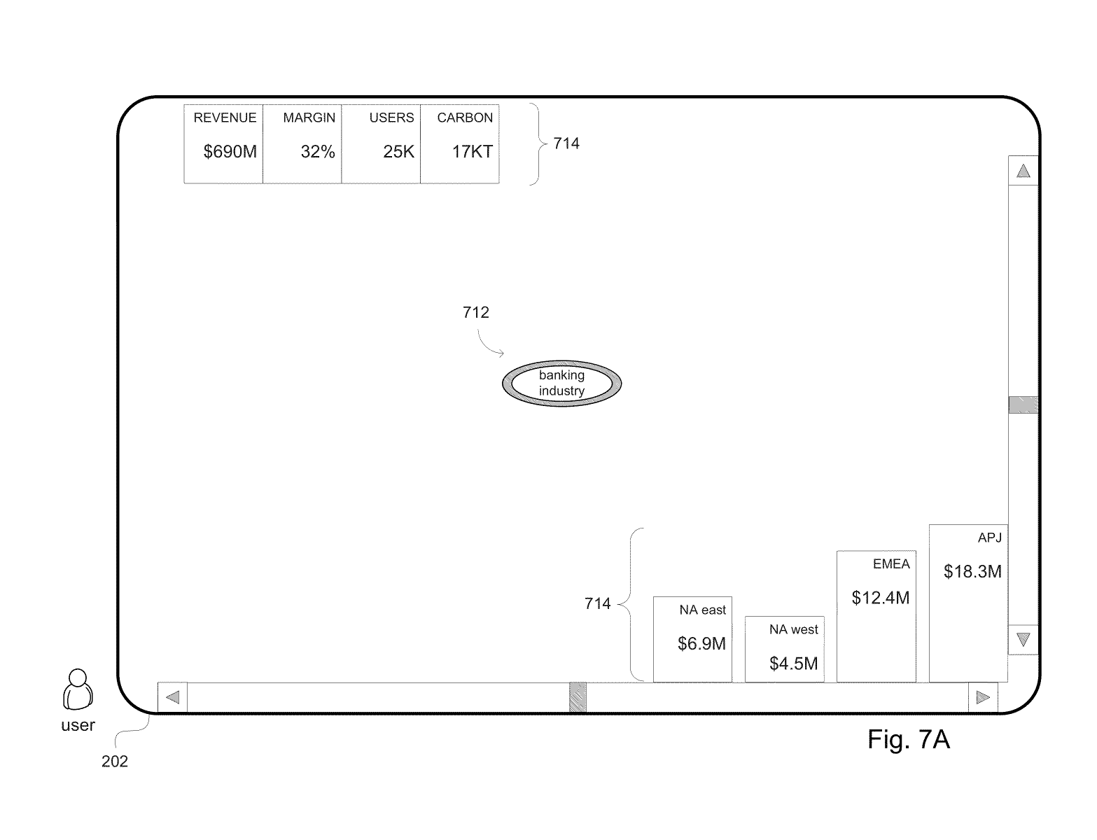

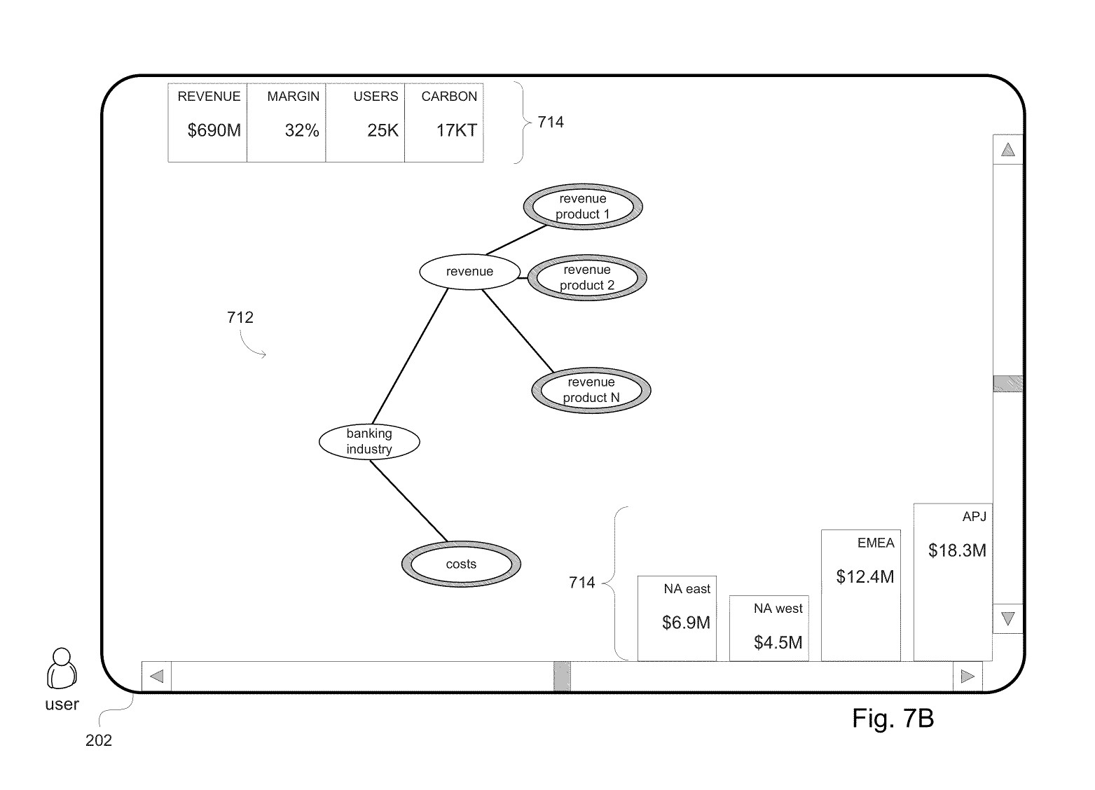

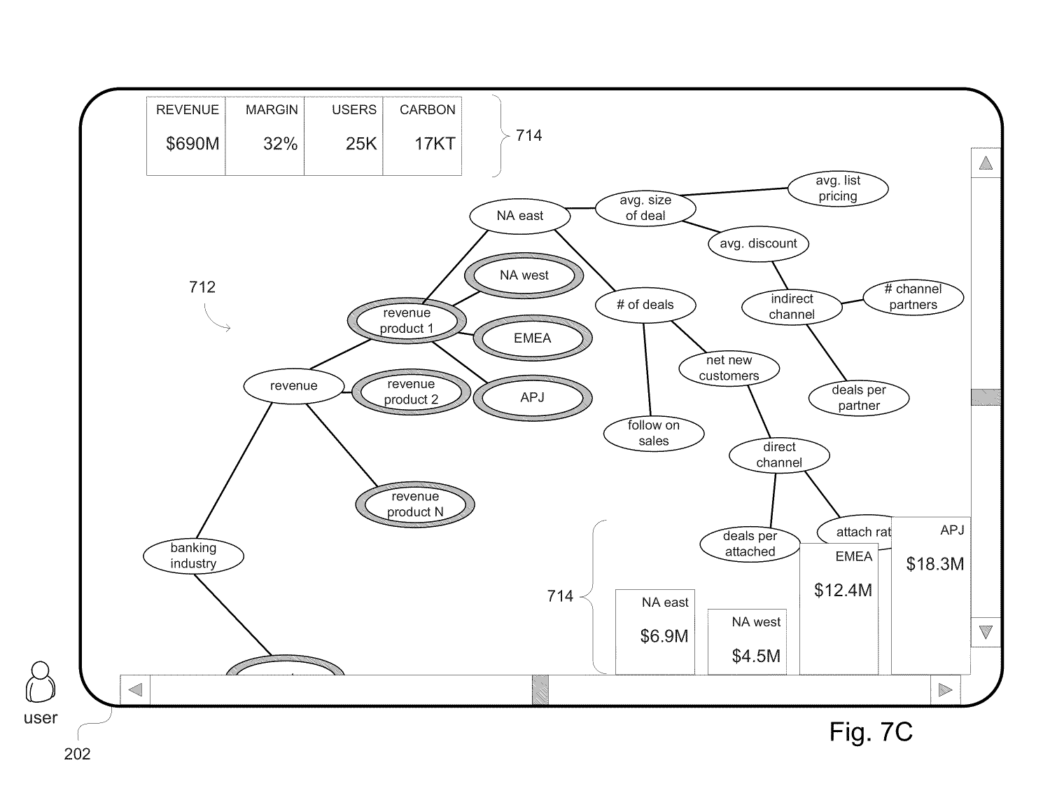

The density of information available in a business enterprise requires being able to properly visualize such information by compressing massive amounts of data into many different views in order to provide a meaningful model of the business. Referring to FIGS. 7A-7C, for example, the user might begin with the highest level view of a driver tree 712, namely the “banking industry” node. The user may assess the state of the business enterprise by inspecting the numbers presented in the various outcome windows 714. The user may drill down (zoom in) the driver tree for additional detail. FIG. 7B illustrates an example of drilling down to the next level, where the “banking industry” node is expanded. FIG. 7C illustrates an example of additional levels of drill-down. Being able to collapse portions of a driver tree into a single node allows for relevant information to be displayed in a non-cluttered fashion, allowing the end user to focus on problem areas.

Developing and building the driver tree to model a business enterprise may involve various organizations within the enterprise. Initially, the developer may be an in-house IT person who establishes a set of generic business model template nodes. Such person may create the necessary connectivity to various internal and external data sources. These template nodes may be specific to different areas of the business enterprise, allowing higher level developers to construct driver tree models specific to the enterprise operations. Business analysts may then step in to facilitate the end user experience by making modifications to the driver tree models to accommodate specific custom business rules. Business analysts may ensure that data mapping to the models is correct. The end user are users such as executives or top-line managers within different organizational units in the enterprise. They navigate the driver tree to test theoretical business scenarios.

Embodiments of the driver tree GUI 202 in accordance with principles of the present invention allow for a driver tree to be used in various ways. Four usage scenarios will be described to illustrate the advantages of the present invention. Each usage scenario allows a user to simulate changes to business drivers and generate possible outcomes for review. If users believe any of the recommendations are unattainable, they can reset their input to more realistic levels and the driver tree GUI 202 to view the results of the new constraints.

Usage Scenario: “I have an Idea.”

This scenario involves users trying to understand the impact of a business idea. For example, “If I open 10 additional stores what will my P&L look like?” The driver tree GUI 202 can answer questions the way people think about things. Results are easily extrapolated and simulated based on the question asked.

Usage Scenario: “I have a Goal, how do I Achieve it?”

This scenario involves users looking at the business with a firm goal or end result in mind. For example, “What do I need to do in order to grow sales by 20%?” This usage case is based on knowing the destination but not understanding how to get there. The driver tree GUI 202 incorporates the underlying knowledge and can provide answers without requiring the user to have to know or understand the details of the business.

Usage Scenario: “I want Input from the Rest of the Organization.”

This collaboration scenario involves sharing a model with others in the organization. Different users can provide separate insight and information that refine certain assumptions. All input is merged and compared, creating a strong foundation for analysis collaboration. The driver tree GUI 202 facilitates collaborative efforts. This aspect of the present invention is disclosed in commonly owned and concurrently filed U.S. application Ser. No. ______, filed ______, entitled “REPRESENTING BUSINESS DRIVERS AND OUTCOMES TO FACILITATE COLLABORATIVE PLANNING” (attorney docket no. 000005-018600US), which is incorporated herein by reference in its entirety for all purposes.

Usage Scenario: “I want to Compare My Performance to the Industry.”

This scenario involves the addition of third party data and models. Many vendors have solid industry benchmark and historical data to share. This type of industry data can go a long way to enrich an organization's business model and support business decisions.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A method for visualizing a driver tree model for a business enterprise comprising operating a computer system to perform steps of:
receiving node inputs indicative of a plurality of node elements, each node element representative of a business lever in the business enterprise;
receiving placement information indicative of positions of the node elements relative to each other;
receiving connector information indicative of connections between the node elements;
receiving one or more calculations associated with one or more node elements;
receiving node data associated with at least some of the node elements;
displaying the node elements on a display device using the placement information;
displaying connectors among the node elements on the display device using the connector information, thereby generating a visual representation of the driver tree model;
displaying one or more calculation results on the display device, including evaluating one or more of the calculations, wherein a calculation is evaluated if node elements associated with the calculation contain associated node data; and
automatically updating one or more calculations among one or more nodes when a node element receives new node data and updating a display of the one or more calculation results.

2. The method of claim 1 wherein the step of receiving node data includes receiving data from a user or receiving data from results of a computation.

3. The method of claim 1 wherein the step of receiving node data includes receiving data that results from an evaluation of modeling information.

4. The method of claim 3 wherein the modeling information is a spreadsheet.

5. The method of claim 1 further comprising receiving information indicative of a data source, wherein the step of receiving node data includes receiving data from the data source.

6. The method of claim 5 wherein the data source is a data source within the business enterprise.

7. The method of claim 5 wherein the data source is a data source is other than a data source within the business enterprise.

8. The method of claim 1 further comprising receiving modeling information which models at least a portion of the business enterprise,
wherein the step of receiving node inputs comprises identifying business drivers in the modeling information,
wherein the step of receiving placement information comprises generating the placement information based on relationships among the business driver in the modeling information,
wherein the step of receiving connector information comprises identifying dependencies between the business driver in the modeling information,
wherein the step of receiving one or more calculations comprises identifying calculations in the modeling information.

9. The method of claim 8 wherein the modeling information is a spreadsheet.

10. The method of claim 1 further comprising:
receiving first input designating a first node, the first node representative of a second driver tree that is representative of a portion of the business enterprise; and
in response to receiving the first input, redisplaying the visual representation of the driver tree model to include node elements that comprise the second driver tree.

11. The method of claim 1 further comprising receiving input representative of a portion of the visual representation of the driver tree and replacing said portion with a replacement node element.

12. A computer system in a business enterprise comprising:
a computing subsystem comprising a display device,
the computing subsystem comprising computer executable programs configured to operate the computing subsystem to:
receive node inputs indicative of a plurality of node elements, each node element representative of a business lever in the business enterprise;
receive placement information indicative of positions of the node elements relative to each other;
receive connector information indicative of connections between the node elements;
receive one or more calculations associated with one or more node elements;
receive node data associated with at least some of the node elements;
display the node elements on the display device using the placement information;
display connectors among the node elements on the display device using the connector information, thereby generating a visual representation of the driver tree model;
display one or more calculation results on the display device, including evaluating one or more of the calculations, wherein a calculation is evaluated if node elements associated with the calculation contain associated node data; and
automatically updating one or more calculations among one or more nodes when a node element receives new node data and updating a display of the one or more calculation results.

13. The computer system of claim 10 wherein the node data is from a user, results of a computation, or modeling information.

14. The computer system of claim 13 wherein the modeling information is a spreadsheet.

15. The computer system of claim 10 wherein the computer system is further configured to receive information indicative of a data source, wherein the node data is obtained from the data source.

16. The computer system of claim 15 wherein the data source is a data source that is not a data source within the business enterprise.

17. A non-transitory computer readable storage medium having stored thereon computer executable program code configured to operate a computer to perform steps of:
receiving node inputs indicative of a plurality of node elements, each node element representative of a business lever in the business enterprise;
receiving placement information indicative of positions of the node elements relative to each other;
receiving connector information indicative of connections between the node elements;
receiving one or more calculations associated with one or more node elements;
receiving node data associated with at least some of the node elements;
displaying the node elements on a display device using the placement information;
displaying connectors among the node elements on the display device using the connector information, thereby generating a visual representation of the driver tree model;
displaying one or more calculation results on the display device, including evaluating one or more of the calculations, wherein a calculation is evaluated if node elements associated with the calculation contain associated node data; and
automatically updating one or more calculations among one or more nodes when a node element receives new node data and updating a display of the one or more calculation results.

18. The non-transitory computer readable storage medium of claim 17 further comprising executable program code configured to operate the computer to perform steps of receiving modeling information which models at least a portion of the business enterprise,
wherein the step of receiving node inputs comprises identifying business drivers in the modeling information,
wherein the step of receiving placement information comprises generating the placement information based on relationships among the business driver in the modeling information,
wherein the step of receiving connector information comprises identifying dependencies between the business driver in the modeling information,
wherein the step of receiving one or more calculations comprises identifying calculations in the modeling information.

19. The non-transitory computer readable storage medium of claim 18 wherein the modeling information is a spreadsheet.

20. The non-transitory computer readable storage medium of claim 17 further comprising executable program code configured to operate the computer to perform steps of:
receiving first input designating a first node, the first node representative of a second driver tree that is representative of a portion of the business enterprise; and
in response to receiving the first input, redisplaying the visual representation of the driver tree model to include node elements that comprise the second driver tree.
